(19) United States
(12) Patent Application Publication
(10) Pub. No.: US 2018/0148607 A1
(43) Pub. Date: May 31, 2018

(54) POLISHING COMPOSITIONS WITH IMPROVED LOW TEMPERATURE PROPERTIES

(71) Applicant: 3M INNOVATIVE PROPERTIES COMPANY, St. Paul, MN (US)

(72) Inventor: Denis V. Agapkin, Moscow (RU)

(21) Appl. No.: 15/576,128

(22) PCT Filed: May 20, 2016
(86) PCT No.: PCT/US2016/033435

§ 371 Date: Nov. 21, 2017

(30) Foreign Application Priority Data
May 27, 2015 (RU) 2015120015

(51) Int. Cl. C09G 1/04; C09G 1/02; C11D 7/24; C11D 7/20; C11D 11/00

(52) U.S. Cl. CPC C09G 1/04; C09G 1/02; C11D 11/0041; C11D 7/20; C11D 7/24

(57) ABSTRACT

A polishing composition with improved stability at low temperatures comprising from 10 to 50% by weight of water, from 10 to 60% by weight of hydrocarbons, from 0.5 to 5% by weight of one or more organic acids and including its salts wherein the organic acids have from 1 to 10 carbon atoms, further comprising additives wherein the total amounts of ingredients give 100% by weight.

### FIELD

The present disclosure relates to aqueous compositions containing one or more hydrocarbons that have improved stability when subjected to low temperatures. The compositions are suitable as polishing compositions for high gloss surfaces.

### BACKGROUND ART

Compositions containing hydrocarbons can be used to remove stubborn dirt and can be polished to produce a glossy finish on the surface. Motor vehicle polishing compositions allow to remove dirt and cover up fine scratches on the painted vehicle surface. Polishing compositions are typically aqueous compositions with a hydrocarbon component, typically a mineral oil, which may form a film on the surface and can be buffed to create a glossy appearance. Polishing compositions may further contain small inorganic particles that assist in the removal of weathered paint, soil and old built-up polish. Silicone oils are incorporated in some types of polishing compositions to function as lubricants, water repellants and anti-stick agents. However, due to their anti-stick properties polishing compositions containing silicone may have disadvantages, for example when repainting is necessary. Therefore, some polishing compositions are offered as silicone-free compositions and do not contain any added silicone oils.

Due to the rather high water content the polishing compositions are susceptible to freezing at low temperatures. Once the compositions have frozen their properties may be inferior when they reach room temperature again. In particular such compositions tend not to reach their original viscosity anymore which impacts on their handling and reduces their performance. In areas where low temperatures are reached frequently, such polishing compositions have to be stored in heated warehouses and transported in heated containers. While anti-freeze agents such as glycols may be used to reduce the freezing temperature of aqueous compositions, their amount necessary to effect a significant reduction in the freezing temperature would be so high such that it would significantly impact on the viscosity of the composition. The problem may be even more prominent for polishing compositions that are essentially free of silicone oils.

### SUMMARY

Therefore, there is provided a polishing composition comprising from 10 to 50% by weight of water, from 10 to 60% by weight of a hydrocarbon component comprising alkanes having from 5 to 36 carbon atoms, from 0.5 to 5% by weight of one or more salts of a C₁-C₆ organic acid, further comprising additives wherein the total amounts of ingredients give 100% by weight and wherein the composition has a viscosity of from about 15,000 (fifteen thousand) cp to about 65,000 (sixty-five thousand) cp (Brookfield viscometer at 20° C.) and is essentially free of silicone oils.

In a further aspect there is provided a process of polishing the finished surface of a motor vehicle comprising applying the polishing composition to the area of the surface to be polished, and rubbing the composition using a cloth or pad.

In yet another aspect there is provided a coating on at least one area of the finished surface of a motor vehicle obtained by applying the polishing composition.

### DETAILED DESCRIPTION

Before any embodiments of this disclosure are explained in detail, it is to be understood that the disclosure is not limited in its application to the details of construction and the arrangement of components set forth in the following description. The invention is capable of other embodiments and of being practiced or of being carried out in various ways. Also, it is to be understood that the phraseology and terminology used herein is for the purpose of description and should not be regarded as limiting. Contrary to the use of “consisting”, the use of “including,” “containing”, “comprising,” or “having” and variations thereof is meant to encompass the items listed thereafter and equivalents thereof as well as additional items. The use of “a” or “an” is meant to encompass “one or more”. Any numerical range recited herein is intended to include all values from the lower value to the upper value of that range. For example, a concentration range of from 1% to 50% is intended to be an abbreviation and to expressly disclose the values between the 1% and 50%, such as, for example, 2%, 40%, 10%, 30%, 1.5%, 3.9% and so forth.

Weight percentages are abbreviated herein below and above as ‘% wt.’ or ‘% by weight’. Unless specified otherwise the weight percentages are based on the total amount of the composition. The total amount of the composition corresponds to 100% by weight.

The compositions provided herein typically have a viscosity (20° C.+/−1° C., Brookfield viscometer) of from about 20,000 to about 60,000 centipoise (cp); preferably from about 30,000 to about 58,000 (cp) and more preferably from about 35,000 to about 57,000 cp. The compositions have an improved low temperature stability in that their viscosity does not significantly change after being subjected to a low temperature regime. Preferably the compositions have the same viscosity at ambient temperature (20° C.+/−1° C.) before and after the compositions were kept at −15° C. for 6 hours and then allowed to regain room temperature (20° C.+/−1° C.). In some embodiment the viscosity of the composition after the low temperature regime at −15° C. for 6 hours is reduced by less than 15% of its original value, preferably less than 8% and more preferably less than 5%. In some embodiments the viscosity of the composition does not get reduced by more than 8% of its original value after being subjected to −20° C. for 6 hours or even to −25° C. for 6 hours before the compositions were allowed to reach room temperature again.

The composition provided herein contains at least an aqueous component and at least a hydrocarbon component. These components may be present in at least 10% by weight, preferably at least 15% by weight and more preferably at least 20% by weight. The compositions may further comprise inorganic particles as a third component. The inorganic particles may be present in at least 10% by weight, preferably at least 15% by weight. The compositions may further comprise additives selected from surfactants, lubricants and other ingredients as will be described below. Their amounts can vary depending on the type of ingredients and optimized performance but are selected to reach the above mentioned viscosity range. Preferably the compositions are free or essentially free of silicone oils. ‘Essentially free’ as used herein means that no silicone oils are added to the compositions but their presence as impurity in one or the other ingredients may be tolerated. Typically such amounts are less than 5% by weight, less than 1% by weight, or even less than 0.5% by weight. ‘Free of silicone oils’ as used herein means no silicone oils are present. Silicone oils are polymerized siloxanes, or polysiloxanes, i.e. compounds with repeating Si—O—Si units that further comprise organic residues, i.e. residues containing carbon and hydrogen atoms. They may be described as polymers containing [R₂SiO]n units wherein R represents identical or different organic residues like aliphatic or aromatic residues. The letter n indicates that a plurality of such groups is present, i.e. that such groups are repeating groups.

The pH of the compositions is typically between 6 to 8.

The compositions provided herein are suitable for polishing high gloss surfaces, in particular those of motor vehicles. The compositions are believed to form a film on the surface after the compositions have been rubbed onto the surface and dried. The film may cover up fine scratches on the finish. The film may be rubbed with a cloth or polishing pad to provide a glossy shine.

### Aqueous Component

The aqueous component is water. The water may be purified water, e.g. distilled water. The composition typically contain at least 10% and up to about 50% by weight of water (based on the total weight of the composition). Preferred amounts include from about 20% to about 40% by weight (based on the total weight of the composition).

### Hydrocarbon Components

The hydrocarbon components includes one or more cyclic, linear or branched alkanes, typically alkanes having at least 5 carbon atoms, preferably alkanes having more than 5 carbon atoms. The hydrocarbon components typically includes mixtures of several alkanes, preferably mixtures of cyclic and non-cyclic alkanes. Typical mixtures include mixtures containing alkanes with 5 to 9 carbon atoms, or mixtures with 6 to 12 carbon atoms, or mixtures with 9 to 16 carbon atoms. The hydrocarbon component may comprise a combination of mixtures of alkanes with 5 to 16 carbon atoms and mixtures of alkanes with 24 to 36 carbon atoms. Typical hydrocarbon components include but are not limited to mineral oil (CAS number 8042-47-5), hydrosulfurized naptha (CAS number 64742-82-1, kerosene (CAS number 8008-20-6), paraffine wax (CnH2n+2 with n between 24 and 36; CAS No. 8002-74-2) and combinations thereof.

The compositions may contain from 20 to 50% weight (based on the total weight of the composition) of hydrocarbon components.

### Inorganic Particles

Inorganic particles suitable for the compositions of the present disclosure include particles containing silicon oxide, magnesium oxide, aluminium oxide and combinations thereof. The particles may or may not be mixtures of different kinds of inorganic materials. Preferably the inorganic particles comprise aluminium oxide particles or are predominantly aluminium oxide particles, which means at least 51%, preferably at least 90% by weight of the particles are aluminium oxide particles. The particle may have a size of up to 100 μm, preferably up to 50 μm. Larger particles may risk the surface being scratched. The inorganic particles may be present in amounts of up to about 40% wt, for example, from about 15 to about 40% wt., preferably from about 20 to about 35% wt. (based on the total weight of the composition).

Organic Acids and their Salts

Suitable organic acids and their salts include alkanoic acids. The acids may be carboxylates, phosphoric acids, phosphonic acids, sulfonates. Preferably, the acids are carboxylates. The acids may be monoacids, diacids or triacids. In a preferred embodiment the acids are monoacids. The acids may contain from 1 to 6 carbon atoms (C₁-C₆ acids), preferably from 1 to 3 carbon atoms. Specific examples include formic acid, acetic acid, propionic acid. The acids may be present in their acidic form or they may be present as their salt. Preferably, the acids are present as salts. For example, the acids may be present as potassium salts, sodium salts, ammonium salts, calcium salts and magnesium salts. The acids may be present as a combination of different salts. In a preferred embodiment a combination of acids is used and more preferably the acids are used in that combination as salts. Specific combinations include but are not limited to a combination of C₁- and C₂-acid salt, a combination of a C₁- and a C₃-acid salt and a combination of a C₂- and a C₃-acid salt. The acids and their salts may be present in the compositions in amounts of from about 0.1 to 10% by weight, preferably between about 0.5 and 5% by weight (based on the total weight of the composition).

### Surfactants

The compositions according to the present disclosure may comprise from about 0 to 20% by weight of surfactants, preferably from about 2 to about 10% by weight, and most preferably not more than 15% by weight of surfactants. The weight percentages are based on the total weight of the composition.

The composition may contain anionic, non-ionic and cationic surfactants and combinations thereof, including combinations of non-ionic surfactants only, combinations of only anionic surfactants and combinations of only cationic surfactants, as well as combinations of non-ionic and anionic surfactants, and combinations of non-ionic and cationic surfactants.

Preferably, the compositions comprise at least one non-ionic surfactant. Specific examples of nonionic surfactants include but are not limited to polyoxyethylenes such as alcohol ethoxylates and alkylphenol ethoxylates; carboxylic esters such as glycerol esters, polyoxyethylene esters; anhydrosorbitol esters, such as ethoxylated anhydrosorbitol esters; natural ethoxylated fats, oils, and waxes; glycol esters of fatty acids; alkyl polyglycosides; carboxylic amides, such as diethanolamine condensates, monoalkanolamine condensates, and polyoxyethylene fatty acid amides; fatty acid glucamides; polyalkylene oxide block polymers; and poly(oxyethylene-co-oxypropylene)nonionic surfactants. Specific examples of suitable emulsifiers include Triton N-11, Synperonic OP11EO, Synperonic 91/6, Tergitol 15-S-12, Tergitol 15-S-9, Tergitol 15-S-7, Newcol 1310, and Dispanol TOC. Preferred emulsifiers include Newcol 1308FA(90), Ethox 4031 Mod 38, Ethox 4031 Mod 64, Synperonic OP10EO, and Triton X-100. Preferred examples of non-ionic surfactants include non-aromatic surfactants, more preferably, non-aromatic surfactants comprising at least one cyclic unit.

Examples of suitable anionic surfactants include alkyl sulfates wherein the alkyl group may or may not be interrupted once or more than once with ether oxygens. Examples include but are not limited to sodium lauryl sulfate and ammonium lauryl sulfate. Other suitable anionic surfactants are carboxylic acid salts of straight-chain fatty acids; sulfuric acid ester salts such as sulfated tallow alcohols or sulfated synthetic alcohols from linear olefins; sulfated polyoxyethylenated straight-chain alcohols with structure of R(OC₂H₄)ₓSO₄⁻M⁺, wherein R is a straight chain or branched chain C₄-C₂₀-alkyl group and x is at least 2; and sulfated triglyceride oils.

Suitable cationic surfactants include Ethomeen T/12, Ethomeen T/15, Ethomeen 18/15, Ethomeen 18/25 and Ethomeen 18/60. Other suitable cationic surfactants are long-chain amines and their salts. These are primary amines derived from animal and vegetable fatty acids and tall oil, synthetic C₁₂-C₁₈ primary, secondary, or tertiary amines; diamines and polyamines and their salts with structure of (RCONHCH₂CH₂)₂NH, wherein R is a straight chain or branched chain C₄-C₂₀-alkyl group; polyoxyethylenated (POE) long-chain amines with structure of RN[(CH₂CH₂O)ₓH]₂, wherein R is a straight chain or branched chain C₄-C₂₀-alkyl group and x indicating repeating groups; quaternary polyoxyethylenated long-chain amines with structure of RN(CH₃)[(C₂H₄O)ₓH]₂⁺, wherein R is a straight chain or branched chain C₄-C₂₀-alkyl group and x indicating repeating units; and amine oxides such as —N—C₈-C₂₀-alkyldimethylamine oxides.

### Additives

The compositions may contain from 0 to 20% by weight of additives, typically from 1 to 10% by weight (based on the total weight of the composition), preferably less than 8% by weight.

Additives include polyols of the general formula HO—R—OH wherein R is selected from linear or branched alkylenes, hydroxyl alkylenes and polyhydroxy alkylenes wherein the alkylene unit may be interrupted once or more than once by ether oxygens and wherein the alkylene unit has at least two carbon atoms and less than 12 carbon atoms, preferably less than 7 carbon atoms. Examples include but are not limited to ethane-1,2-diol, propane-1,3-diol, propane-1,2,3-triol (glycerine), diethylene glycol, ethylene glycol dimethanol ether and combinations thereof. Such polyols may serve as lubricants. In one embodiment the composition comprises at least 0.1% by weight of such polyols, preferably glycerine, but in an amount of up to, preferably less than, 10% by weight, preferably less than 5% by weight (based on the total weight of the composition).

Other additives include but are not limited to fillers, thickening agents, biocides, antioxidants, UV-stabilizers, wetting agents, colorants, pH adjusting agents and buffers. Such other additives may be absent or present in amounts of from about 0.5 to about 10% by weight.

### Application of the Compositions

The compositions according to the present disclosure can be prepared as is typically done in the art for making polishing compositions. The ingredients are combined and homogenized. Typically all liquid components are added and the composition is stirred. The solid components are then added batchwise. The end viscosity may be fine-tuned to the desired level by adding thickeners.

For use as polishing compositions the compositions may be applied to the surface of to be treated. The compositions may be applied to the surface using a cloth or polishing pad. After the compositions have dried they may be buffed using a cloth or a polishing pad.

The following examples are provided to illustrate the present disclosure but with no intention to limit the scope of the disclosure to the embodiments shown in these examples.

### Examples

A polishing composition was prepared using the ingredients and amounts as indicated in table 1 (comparative example, C₁). To prepare the compositions all ingredients were added to water and were then stirred at room temperature to achieve a homogenous past. Various compositions were prepared in the same way except that organic acids were added in the amounts indicated in table 1 and the amount of water was reduced to keep the overall weight of the compositions at 100% wt.

The samples were subjected to a low temperature regime and exposed to the temperatures indicated in table 2. The samples were kept at −15° C. for 6 hours. The physical state of the samples (frozen or not frozen) was examined by visual inspection (paste appeared to be solid and could not be squeezed out of sample holder). Then the samples were allowed to reach room temperature and their viscosity was determined (Brookfield RVF viscometer, at a temperature of 20° C.+/−1° C., T-bar spindle type T-B at 4 rpm. The operating manual for the viscometer can be consulted to identify the appropriate measuring conditions as known to the person skilled in the art). Then the samples were subjected to the next low temperature step at −20° C. for 6 hours and allowed to regain room temperature. This procedure was repeated several down to a temperature of −28° C. as indicated in table 2.

TABLE 1
ingredients of test samples

| Ingredients | | | | | | |
|---|---|---|---|---|---|---|
| (%. Wt) | C1 | Ex 1 | Ex 2 | Ex 3 | Ex 4 | Ex 5 |
| Water | 31.70 | 27.70 | 27.70 | 29.70 | 27.70 | 29.70 |
| Hydrocarbon | 34 | 34 | 34 | 34 | 34 | 34 |
| component | | | | | | |
| Aluminum | 23 | 23 | 23 | 23 | 23 | 23 |
| oxide | | | | | | |
| (particle size | | | | | | |
| from 3-45 | | | | | | |
| microns) | | | | | | |
| Glycerin | 1 | 1 | 1 | 1 | 1 | 1 |
| Additives | 11.3 | 11.3 | 11.3 | 11.3 | 11.3 | 11.3 |
| Potassium | | | 2 | 1 | 2 | |
| proprionate | | | | | | |
| Potassium | | 4 | 2 | 1 | | 2 |
| formiate | | | | | | |
| Sodium acetate | | | | | 2 | |
| Total (%. Wt) | 100 | 100 | 100 | 100 | 100 | 100 |

TABLE 2
Test results after low temperature exposure

| | | | | | | | Viscosity after |
|---|---|---|---|---|---|---|---|
| | | | | | | | subjected to −15° C. |
| | | | | | | | before composition |
| | | | | | | | reached ambient |
| | | | | | | Viscosity | temperature again. |
| | | | | | | before | Viscosity measured |
| | −15° | −20° C. | −23° C. | −26° C. | −28° C. | freezing | at room temperature |
| C1 | frozen | | | | | 49000 | 26000 |
| Ex1 | Not frozen | Not frozen | frozen | | | 49000 | 49000 |
| Ex2 | Not frozen | Not frozen | Not | Not frozen | Not frozen | 55000 | 55000 |
| | | | frozen | | | | |
| Ex3 | Not frozen | frozen | | | | 51000 | 50000 |
| Ex4 | Not frozen | Not frozen | frozen | | | 55000 | 56000 |
| Ex5 | Not frozen | Not frozen | frozen | | | | |

1. A polishing composition comprising from 10 to 50% by weight of water, from 10 to 60% by weight of a hydrocarbon component comprising alkanes having from 5 to 36 carbon atoms, from 0.5 to 5% by weight of one or more salts of a C₁-C₆ organic acid, and additives wherein the total amounts of ingredients give 100% by weight and wherein the composition has a viscosity of from about 15000 cp to about 65000 cp (Brookfield viscometer at 20° C.).

2. The polishing composition according to claim 1 wherein the composition reaches its original viscosity measured at 20° C. after it has been subjected to −15° C. for 6 hours and allowed to regain room temperature (20° C.) or wherein the viscosity is reduced by less than 10%, preferably less than 5%, of its original value.

3. The composition according to claim 1 that is not-frozen at a temperature of −20° C.

4. The polishing composition of claim 1 further comprising inorganic particles.

5. The polishing composition claim 1 further comprising inorganic particles wherein the inorganic particles comprise aluminium oxide.

6. The polishing composition of claim 1 wherein the inorganic particles are present in an amount up to 40% by weight based on the total weight of the composition.

7. The polishing composition according to claim 1 wherein the alkanes are selected from linear, branched and cyclic alkanes having from 5 to 16 carbon atoms and combinations thereof.

8. The polishing composition according to claim 1 wherein the alkanes are a combination of cyclic and non-cyclic alkanes.

9. The polishing composition according to claim 1 wherein the alkanes are selected from mineral oil, hydrosulfurized naptha, kerosene and combinations thereof.

10. The polishing composition according to claim 1 wherein the alkanes comprise paraffin wax.

11. The polishing composition according to claim 1 wherein the organic acid salts are carboxylates.

12. The polishing compositions according to claim 1 claims wherein the organic acid salts are present in an amount of from about 0.5 to 10% by weight based on the total weight of the composition.

13. The polishing composition according to claim 1 wherein the additives comprise non-ionic, non-aromatic surfactants.

14. The polishing compositions according to claim 1 wherein the additives comprises non-ionic, non-aromatic surfactants containing one or more cyclic units.

15. The polishing composition according to claim 1 wherein the composition is essentially free of silicone oils.

16. The polishing composition according to claim 1 wherein the composition is free of silicone oils.

17. A process of polishing the finished surface of a motor vehicle comprising applying the composition according to claim 1 to the area of the surface to be polished, and rubbing the composition using a cloth or pad.

18. A coating on at least one area of the finished surface of a motor vehicle obtained by applying the polishing composition according to claim 1.
